(19) United States
(12) Patent Application Publication
(10) Pub. No.: US 2004/0190286 A1
(43) Pub. Date: Sep. 30, 2004

(54) Flashlight

(76) Inventor: Leonard T. Chapman, North Hollywood, CA (US)

Correspondence Address: PERKINS COIE LLP, POST OFFICE BOX 1208, SEATTLE, WA, 98111-1208, US

(21) Appl. No.: 10/644,392

(22) Filed: Aug. 19, 2003

Related U.S. Application Data
(63) Continuation-in-part of application No. 10/397,766, filed on Mar. 25, 2003.

(51) Int. Cl. F21L 19/00

(52) U.S. Cl. 362/171

(57) ABSTRACT

A flashlight has a lens moveable relative to an LED. The beam of light provided by the LED can be focused and provides a uniform light pattern across the range of focus. The lens is supported on a front housing section and the LED is supported on a back housing section threaded onto the front housing section. Twisting the front housing section closes a switch providing power to the LED, to turn the flashlight on. A circuit module within the flashlight provides various operating modes including an automatic shut-off timer, to preserve battery life, a dimmer controlled by turning an end cap, a blinking function, and/or a current control function to provide maximum brightness regardless of battery condition.

### BACKGROUND OF THE INVENTION

This application is a Continuation-in-Part of U.S. patent application Ser. No. 10/397,766 filed Mar. 25, 2003, now pending and incorporated herein by reference.

The field of the invention is flashlights. More specifically, the invention relates to a portable hand held battery powered flashlight. For many years, flashlights have used batteries, specifically, dry cells, to power an incandescent bulb. Reflectors around or behind the bulb have been provided to help direct light from the bulb. More recently, with the development of light emitting diodes (LED's), in some flashlights the incandescent bulb has been replaced by an LED. Use of an LED in place of an incandescent bulb as a light source in a flashlight has several advantages. Initially, LED's use less power than incandescent bulbs. As a result, battery life in an LED flashlights can be greatly extended. In addition, LED's are manufactured with specific light emission directivity. Unlike an incandescent bulb, which radiates light in all directions, LED's emit light in specific directions, or within a specific angle. Accordingly, for spot illumination, which is the most common use for flashlights, the directivity of LED's is advantageous. LED's also have an operating life which is far longer than that of most incandescent bulbs. Consequently, the disadvantages of bulb burnout or failure, and the need to replace bulbs relatively frequently, are largely avoided.

While use of LED's in flashlights have several advantages, design challenges remain. In particular, the ability to achieve a uniform beam of light under a wide range of conditions has yet to be achieved with existing flashlights, regardless of whether the light source is an LED, an incandescent bulb or another light source. The directivity (included angle) of existing LEDs is not sufficiently narrow for lighting distant from the flashlight. Even with the most directional LEDs, having a directivity angle of about 15°, the emitted light becomes very faint more than a few feet away from the LED. For various reasons, the light beam of virtually all flashlights is not uniform. The intensity of light in the beam varies. Generally, this variation appears as lighter and darker areas of the beam. Some flashlights produce a beam having an irregular shape, and decreased lighting efficiency, rather than a nearly perfect circle of uniform light.

In the past, several flashlights, especially flashlights having incandescent bulbs, have included beam focusing features. In these types of flashlights, typically a reflector behind or surrounding the bulb is moved relative to the bulb, to change the light beam pattern or to focus the beam. While beam focusing is a useful feature in these types of flashlights, generally, the shape or uniformity of the beam changes as the beam is focused. These types of flashlights are unable to maintain uniform light beam quality over an entire range of focus. As a result, the light beam typically has dark spots and appears dimmer, and the quality of the light beam, in terms of field of illumination, is degraded.

Another drawback with battery powered flashlights is of course the limited life of batteries. While use of LED's can greatly extend battery life, the traditional drawbacks associated with batteries have not been fully overcome. Even with LED flashlights, prolonged use will drain the batteries. Most flashlights have an on/off switch as the only control. Accordingly, if the switch is inadvertently left on, the batteries will be drained. Thus, to maintain the flashlight in a useable condition, the user must remember to turn the flashlight off. While seemingly a simple step, it is often overlooked, especially where the flashlight is carried from a dark location into a bright location, where there are extensive distractions to the user, or where the flashlight is used by young children. To overcome this disadvantage, various flashlights having automatic shut off features have been proposed. However, few, if any of these proposals have found widespread success, either due to design, operation, manufacturing, cost and/or other reasons. In certain uses or circumstances, it is important that the automatic shut off feature be turned off entirely, so that the flashlight is switched on or off manually. This added requirement provides an additional engineering challenge in flashlight design.

Flashlights have been adapted for use in extreme environments. For example, diving or underwater flashlights have been designed to operate in an undersea environment of high water pressure, low temperature, corrosive seawater, etc. While these types of environmental flashlights have met with varying degrees of success, engineering challenges remain in providing a flashlight which can reliably withstand extreme pressures, high and low temperatures, corrosive environment, shock, vibration and other adverse environmental conditions.

Accordingly, it is an object of the invention to provide an improved flashlight.

### SUMMARY OF THE INVENTION

In a first aspect, a flashlight has an aspheric, piano convex, or other suitable lens for focusing light from an LED powered by batteries. As the LED has low power consumption useful battery life in the flashlight is greatly extended. The lens helps to provide a uniform and bright light beam, without the need for a reflector. An LED holder may be used to hold various types of LED in place, and to act as a heat sink.

In a second aspect, the lens is moveable relative to the LED, allowing the beam to be focused. Preferably, the flashlight housing has a front section supporting the lens, and a rear section supporting the LED. With the rear section advantageously threaded into the front section, turning or twisting the front section focuses the light beam. A second lens may also be used in or on the flashlight, especially to provide a bright spot of light at a distant location. The second lens may have a fixed or adjustable position relative to the first lens.

In a third and separate aspect, a flashlight has an electronic timer circuit which automatically turns the flashlight off after a preset interval. As a result, battery power is preserved, even if the flashlight is inadvertently left on. Preferably, the preset interval can be adjusted for a short period of time, such as 5-7 minutes, or for a longer period of time, for example, 15 or 20 minutes. For specialized requirements, the timer can be designed to turn off the flashlight after a preselected interval, or the timer can be disabled to provide continuous operation (until manually turned off). The timer circuit is advantageously combined with an LED as the light source in the flashlight. A current control circuit, selectable via a switch, may be used with or without the timer or other circuits. The current control circuit can be used to maintain the brightness of the bulb or LED, as the batteries discharge over time. A dimmer switch and circuit may also be provided to allow the brightness to be adjusted as desired. A blinking circuit may also be used to cause the bulb or LED to switch on and off in a timed sequence.

In a fourth and separate aspect, a flashlight has multiple lens on a lens base aligned with multiple LED's or lamps. Turning a first section of the flashlight causes the lenses to move towards or away from the LED's, to focus the light, with the lenses remaining axially or optically aligned with the LED's. This design allows a flashlight having multiple LED's to focus the light provided by the LED's.

In a fifth and additional aspects, brightness and lamp control features are provided, including one or more of a current limiter, to maintain brightness as batteries drain, a dimmer, and a blinking feature.

Other further objects and advantages will appear from the following written description taken with the drawings, which show two embodiments. However, the drawings and written description are intended as preferred examples, and not as limitations on the scope of the invention. The invention resides as well as sub combinations of the elements described. Features of one embodiment may be used in different combinations in other embodiments.

### BRIEF DESCRIPTION OF THE DRAWINGS

In the drawings, wherein the same element number indicates the same element in each of the views;

FIG. 1 is a front and side perspective view of the present flashlight.

FIG. 2 is a side view of the flashlight shown in FIG. 1.

FIG. 3 is an exploded front and side perspective view of the flashlight shown in FIG. 1.

FIG. 4 is an enlarged section view of the flashlight shown in FIG. 1.

FIG. 5 is an enlarged exploded section view of the flashlight shown in FIGS. 1 and 4.

FIG. 6 is a top view of the switch housing shown in FIGS. 3-5.

FIG. 7 is a section view taken along line 7-7 of FIG. 6.

FIG. 8 is a section view taken along line 8-8 of FIG. 6.

FIG. 9 is a section view taken along line 9-9 of FIG. 6.

FIG. 10 is a section view of the flashlight shown in FIGS. 1-5, with the front housing section in a fully extended position;

FIG. 11 is a section view showing the flashlight in a fully retracted or off position;

FIG. 12 is a section view showing installation of the switch housing tube.

FIG. 13 is a section view of an alternative embodiment;

FIG. 14 is a section view of another alternative embodiment;

FIG. 15 is an exploded section view of the flashlight shown in FIG. 14;

FIG. 16 is an elevation view taken along line 16-16 of FIG. 15;

FIG. 17 is an elevation view taken along line 17-17 of FIG. 15;

FIG. 18 is an elevation view taken along line 18-18 of FIG. 15;

FIG. 19 is a schematic illustration of the shut off timer circuit in the circuitry module shown in FIGS. 3-5;

FIG. 20 is a schematic illustration of an alternative shut off timer circuit for use in the circuitry module shown in FIGS. 3-5.

FIG. 21 is a section view of an alternative flashlight.

FIG. 22 is a top view of the bulb or LED holder shown in FIG. 21.

FIG. 23 is a right side view thereof.

FIG. 24 is a front view thereof.

FIG. 25 is a rear view thereof.

FIG. 26 is a left side view thereof.

FIG. 27 is a section view taken along line 27-27 of FIG. 22.

FIG. 28 is a section view of the switch housing tube shown in FIG. 21.

FIG. 29 is a back end view thereof.

FIG. 30 is a section view taken along line 30-30 of FIG. 29.

FIG. 31 is a section view of the tube liner shown in FIG. 1.

FIG. 32 is an end view thereof.

FIG. 33 is an enlarged partial section view of the flashlight shown in FIG. 21.

FIG. 34 is a front view of the spring plate shown in FIG. 33.

FIG. 35 is a section view thereof.

FIG. 36 is an enlarged partial section view of an alternative embodiment of the flashlight shown in FIG. 21.

FIG. 37 is an end view of the end knob shown in FIG. 36.

FIG. 38 is a section view thereof.

FIG. 39 is a schematic diagram of circuitry from use in the flashlight shown in FIGS. 1 or 21.

FIG. 40 is a schematic diagram of alternative circuitry for use in the flashlight shown in FIGS. 1 or 21. FIGS. 41 and 42 show alternative flashlight designs having two lenses.

### DETAILED OF DESCRIPTION OF THE DRAWINGS

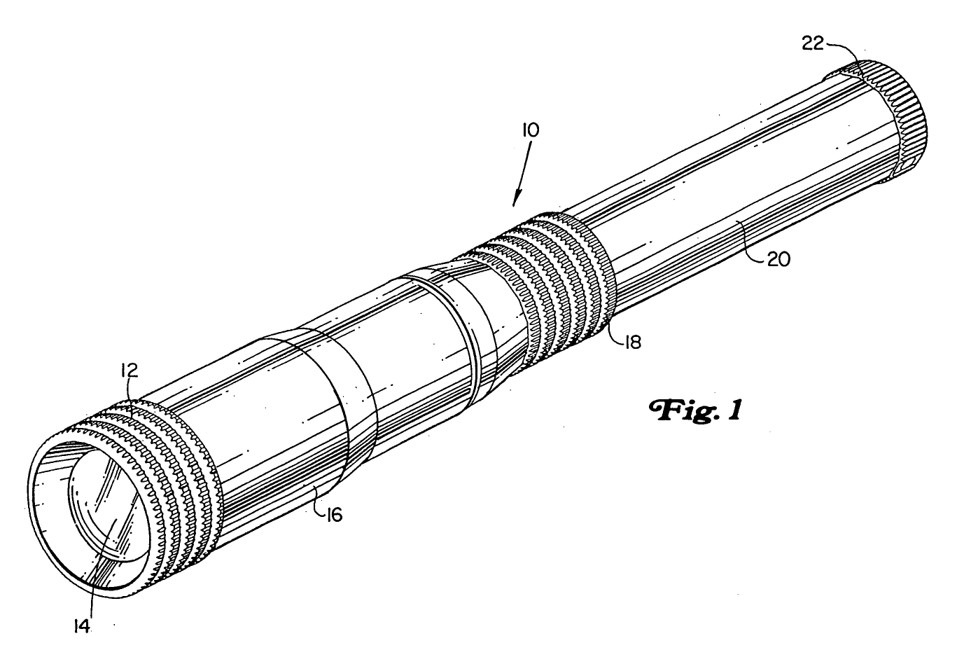

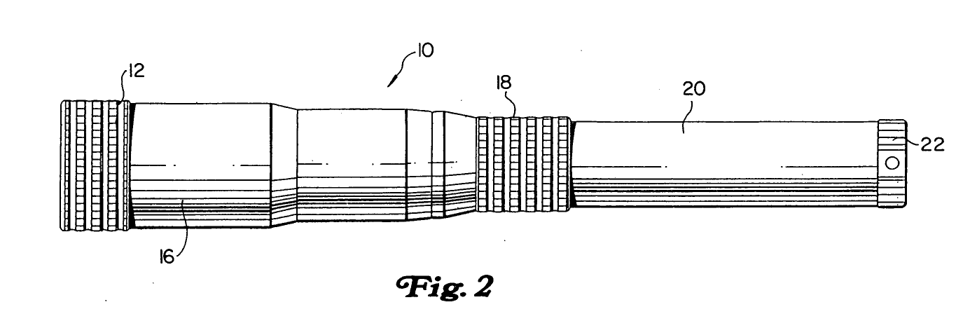

Turning now in detail to the drawings, as shown in FIGS. 1 and 2 a flashlight 10 has a lens 14 within a front cap 12 on a front housing section 16. A rear housing section 20 extends into the front housing section 16. A housing ring 18 is provided on the rear housing section 20 adjacent to the front housing section 16. And end cap 22 on the rear housing section 20 is removable to install or remove batteries from the flashlight 10.

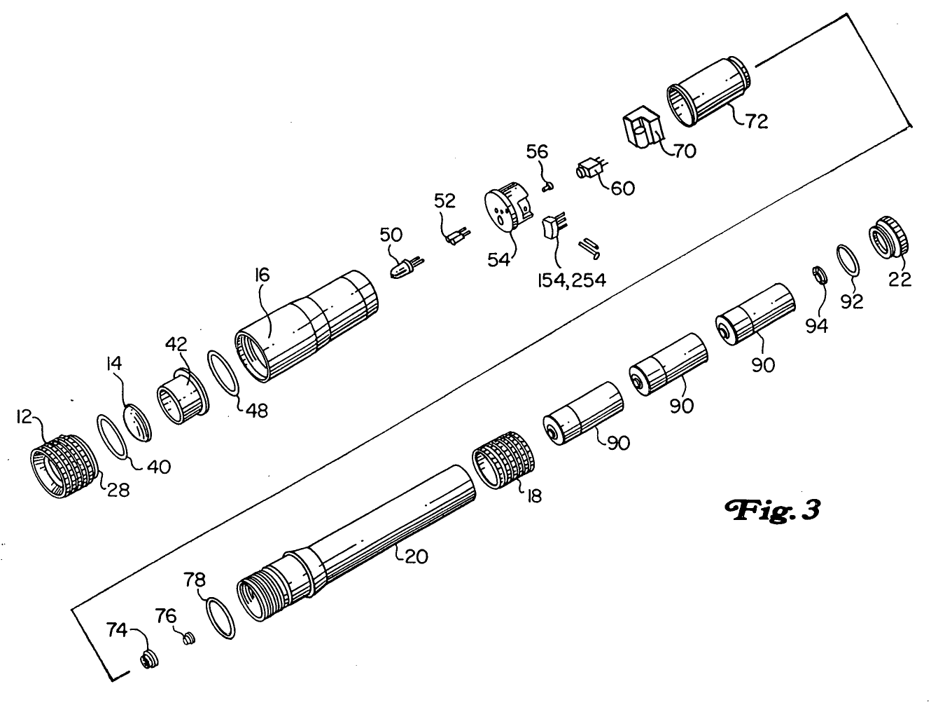

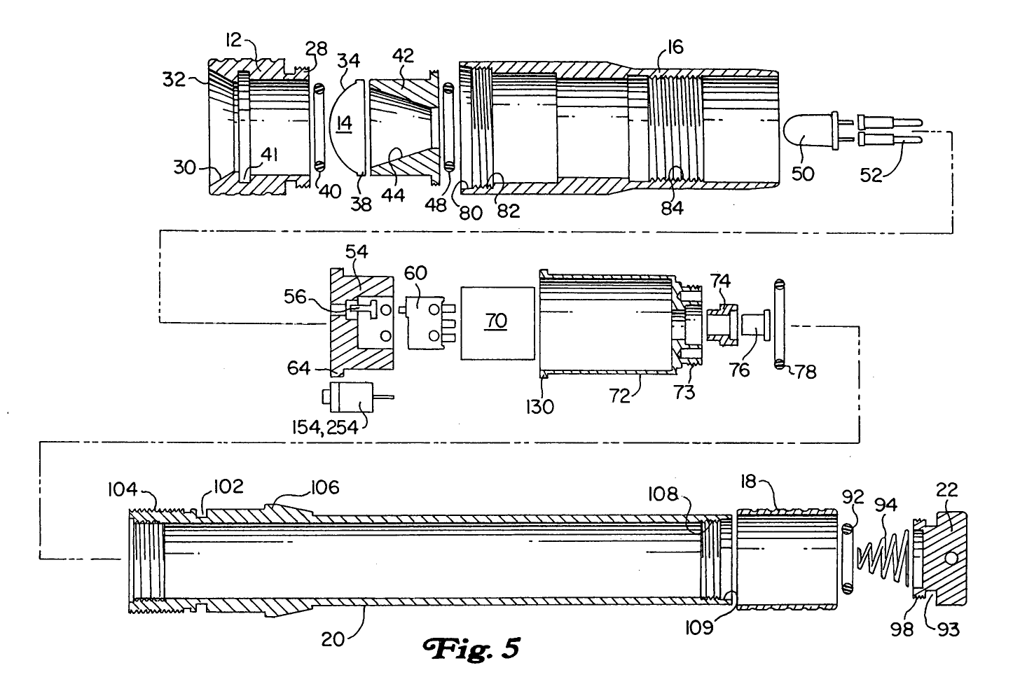

Referring now to FIGS. 3,4 and 5, the front cap 12 has a conical surface 30 at its front end 32. A seal groove 41 is provided adjacent to the conical surface 30 on the front cap 12 as shown in FIG. 5. Screw threads 28 are provided on the back end of the cap 12.

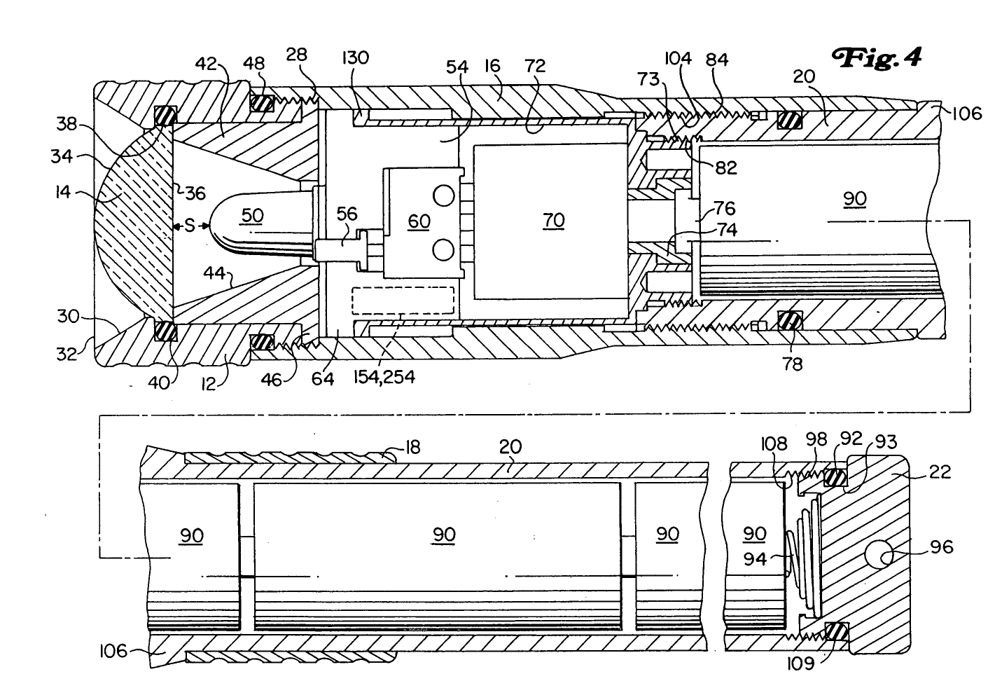

Referring to FIGS. 4 and 5, the lens 14 is preferably an aspheric glass, plano convex, or other suitable (depending on LED selection and focal length) lens. The lens 14 has a spherical front surface 34, and preferably a flat rear surface 36 facing the LED 50. A cylindrical or ring surface 38 at the back end of the lens 14 seals against a seal element, such as an O-ring 40 in the seal groove 41 as shown in FIG. 5. The lens 14 preferably has a focal length of 8-16, 10-14 or 12 mm. The lens is sufficiently thick enough to provide adequate strength to resist pressure equivalent to 9000 feet of water. The center thickness is typically 5-6 millimeters. The term “lens” means an element that focuses or bends light.

Referring to FIGS. 4 and 5, a lamp housing 42 having a conical inside wall 44 is placed or pressed into the front cap 12, holding the lens 14 and O-ring 40 in place. The threaded back end 28 of the front cap 12 is threaded into internal screw threads 82 at the front end of the front housing 16. The lamp housing 42 is longitudinally positioned within the front cap 12 via a flange 46 at the back end of the lamp housing 42 stopping on the back end of the front cap 12. A front cap O-ring or seal 48 seals the front cap 12 to the front housing 16.

The front housing 16 is threaded onto the rear housing 20 via internal threads 84 on the front housing 16 engaged with external threads 104 at the front end of the rear housing 20. The components described above (i.e., the front cap 12, lens 14, O-ring 40, lamp housing 42, and O-ring 48) are all supported on (directly or indirectly) and move with, the front housing 16.

Referring still to FIGS. 4 and 5, the LED, light source or lamp 50 has anode and cathode leads extending into electrical contacts 52 in a switch housing 54. A microswitch 60 is supported within the switch housing 54. A plunger 56 extends from the microswitch 60 through and out of the front end of the switch housing 54, with the plunger biased outwardly against the back surface of the housing 42. The switch housing 54 is supported on or in the front end of a switch housing tube 72. A rim or collar 64 contacts the front end of the switch housing. The contacts 52 extend through contact bores or openings 62 in the switch housing 54, as shown in FIG. 8.

A circuitry module 70 within the switch housing tube 72 is electrically connected to the switch 60, and also to the batteries 90 via a battery contact 76 extending through a tube collar 74 at the back end of the switch housing tube 72. As shown in FIG. 4, a housing seal 78 seals the front end of the rear housing section 20 to the back end of the front housing section 16, while still allowing the front housing section 16 to turn, and shift longitudinally (along a center axis of the flashlight), as the front and rear housing sections are turned relative to each other.

The rear housing section 20 has an open internal cylindrical space for holding the batteries 90. In the embodiment shown in FIGS. 4 and 5, three N size batteries are used. Of course, different numbers and types of batteries may be used, consistent with the requirements of the LED 50 and circuitry module 70 provided. The front end of the rear housing section 20 includes a seal groove 102 as shown in FIG. 5, just behind the external threads 104, to hold and position the housing seal 78. A stop 106 limits the rearward range of travel of the front housing section 16 on the rear housing section 20. A housing ring 18 is pressed onto the rear housing section 20 and positioned adjacent to the stop 106. At the back end of the flashlight 10, threads 98 on the end cap 22 are engaged with rear internal threads 108. An end cap seal or O-ring 92 within a groove 93 on the end cap 22 seals the end cap 22 against a recess 109 in the rear housing section 20. A battery spring 94 grounds the negative terminal of the rear most battery to the rear housing section 20, and forces the batteries 90 into contact with each other and with the battery contact 76. A hole 96 through the end cap 22 allows the flashlight 10 to be mounted on a key chain, key ring or wire.

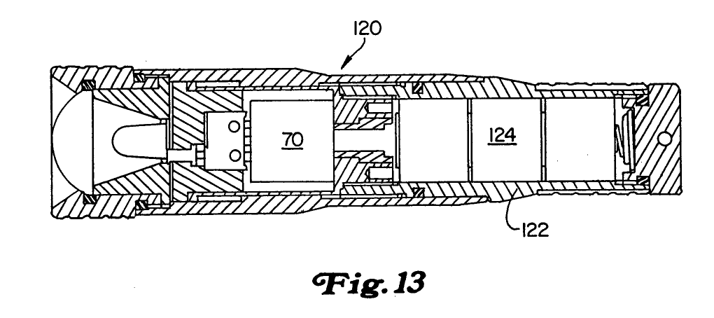

FIG. 13 shows an alternative embodiment having a shorter length than the flashlight shown in FIGS. 1-5. The shorter length is provided by having a shorter rear housing section 122 and using shorter batteries 124. The flashlight 120 in FIG. 13 is otherwise the same as the flashlight 10 shown in FIGS. 1-5.

The LED 50 is preferably an NSPW510BS, with a 50° directivity angle available from Nichia Corporation, Tokyo, Japan. The directivity angle generally is the included angle of the solid cone of light emanating from the LED. Outside of this solid conical angle, there is little or no light. Within the directivity angle, with most preferred LED's, the light is reasonably uniform, with some decrease in intensity near the sides or boundary of the angle. The directivity angle is specified by the LED manufacturer. Other more powerful LEDs will soon be available, which may affect lens selection. The lens 14 is preferably an aspheric 01LAG001, 2 or 111 available from Melles Griot, Carlsbad, Calif., USA. A plano/convex lens or other lenses may also be used. The lens preferably has a high level of strength to better resist pressure, such as water pressure when used underwater. In general, the front or outwardly facing surface of the lens will be curved, domed, or convex, as shown in FIG. 4, to better resist pressure forces.

Experimentation with LED's and lenses reveals that, in terms of flashlight performance, a specific relationship exists between the directivity angle A of the LED and the focal length of the lens f. For preferred performance characteristics, the ratio of A/f is within the range of 3.5 to 6.5, preferably 4 to 6 or 4.5 to 5.5, and more preferably approximately 5.

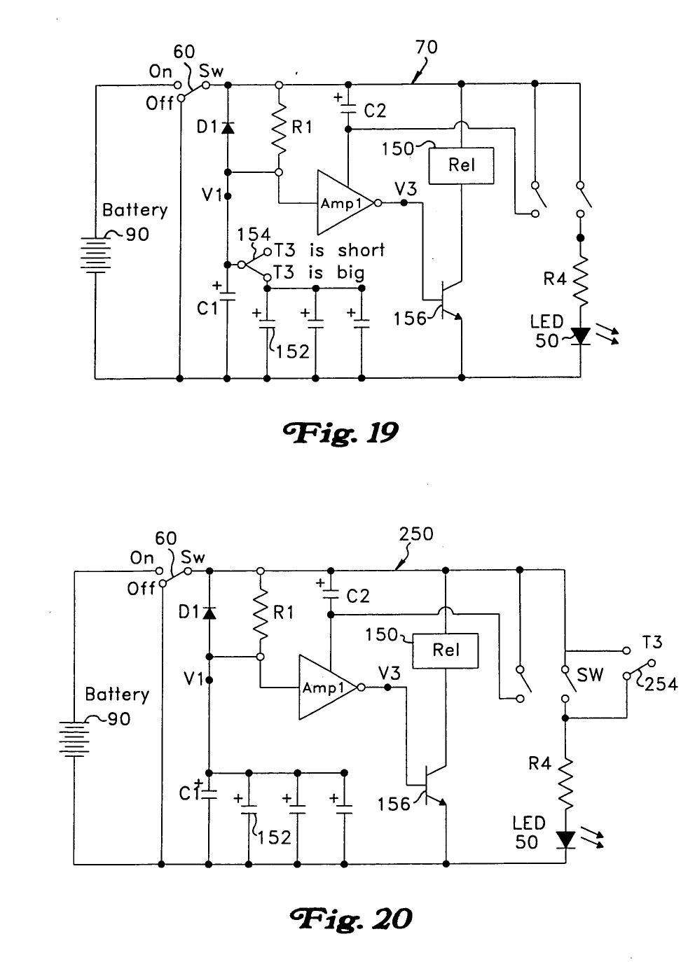

FIG. 4 shows the flashlight 10 in the off position. The front housing section 16 is threaded onto the rear housing section 20, until it comes to the stop 106. In this position, the plunger 56 is almost entirely within the switch housing 54, causing the switch 60 to be in the off position. Electrical power provided from the batteries 90 through the battery contact 76 and circuitry module 70, as well as through the rear housing section 20, is provided to the switch 60. The switch 60 is also connected to the LED, as shown in FIG. 19. As the switch 60 is in the off position, no power is provided to the LED. To turn the flashlight 10 on, the front housing section 16 is turned (counter clockwise in FIG. 1) causing it to move forward via the interaction of the threads 104 and 84. As the front housing section 16 moves forward, the front cap 12, lens 14 and the lamp housing 42 move with it. The LED 50, switch housing 54, plunger 56, switch 60 circuitry module 70 all remain in place, as they are supported within the switch housing tube 72 which is fixed to the rear housing section 20.

As the LED or light source 50 and lamp housing 42 move away from the switch housing 54, the plunger 56, biased by spring force in the switch 60 also moves forward or outwardly. This movement causes the switch 60 to move into an on position. In the on position, the electrical power is provided to the LED 50. To focus the light from the LED or light source 50, the user continues to turn the front housing section 16. This increases the spacing “S” between the lens 14 and the LED 50, allowing light from the LED to be focused to a desired distance. A position stop 130 on the front end of the switch housing tube 72 prevents the front housing section 16 from separating from the rear housing section 20. When the front housing section 16 is turned to its maximum forward position (where further forward movement is prevented by the stop 130), the lens 14 focuses the light to a maximum distance.

Referring momentarily to FIG. 12, the switch housing tube 72 is installed from the front end of the front housing section. The threaded section 73 of the switch housing tube 72 engages with the threads 82 on the front housing section. The spanner tool 75 is inserted through the back end and is used to tighten the switch housing tube 72 in place. The rim or stop 130 at the front end of the switch housing tube acts as a mechanical stop to prevent the front housing section from separating from the rear housing section.

The combination of the LED 50 and the lens 14 allows the flashlight 10 to focus, and also to provide a narrow direct beam of light. The focusing range of the lens 14 allows filaments of the light source, which appear in the beam, to be used as pointers or indicators. A light beam provided by the flashlight 10 has minimal dark spots. In addition, the spot pattern produced by the flashlight 10 is nearly a perfect circle, throughout the entire range of focus. The LED or light source 50 may be provided in various colors.

In general, light from the LED is focused by the lens, and no reflector is needed. However, with some LEDs, use of a reflector, in combination with a lens, may be advantageous. If the LED used has a large directivity angle, for example, 60, 70, 80, 90 degrees, or greater, the lamp housing 42 can also act as a reflector. Specifically, the interior curved or conical surface or wall 44 is made highly reflective, e.g., by polishing and plating. The divergence angle of the wall 44, or curvature, is then selected to reflect light towards the lens. While in this embodiment the reflector (formed by the surface 44) moves with the lens, a fixed reflector, e.g., supported on the switch housing 64, may also be used.

The housing ring 18 and front cap 12 provide convenient grip surfaces for turning the front and rear housings relative to each other to switch the flashlight 10 on and off, and to focus the light beam. The housing seal 78 is the only dynamic seal in the flashlight 10. The other seals are static.

Referring to FIG. 19, when the flashlight 10 is turned on by twisting or turning the front and rear housing sections 16 and 20, the switch 60 closes, or moves to the on position. Battery voltage 90 is then applied to the relay 150, causing the relay to close. Consequently, current flows through the LED 50 generating light. At the same time, the capacitor C1 begins to charge. When the voltage V1 across the capacitor C1 reaches a trigger level, it causes the output of the amplifier 158 (which act as an inverter) to cause the transistor 156 to switch the relay off or open. Power to the LED 50 is then interrupted, preserving the life of the battery 90.

To turn the flashlight 10 back on, the switch 60 is returned to the off position by turning the front and rear housing sections in the opposite directions. With the switch 60 in the off position, the capacitor C1 discharges through the resister R1, returning V1 to zero, and effectively resetting the timer 70. When the switch 60 is moved back to the on position, power is again supplied to the LED, and the flashlight is turned on to provide light. The timer circuit 70 reset to turn off power to the LED after a preset interval. The preset interval is determined by selecting the value of C1. By providing one or more additional capacitors 152 and a capacitor switch 154, the time interval before shut off can be adjusted, or selected from two (or more) preset values. The switch 154 is on or in the switch housing 54, is typically set by the user's preference, and then remains in the shorter or longer internal position. The second switch position can be a timer bypass option.

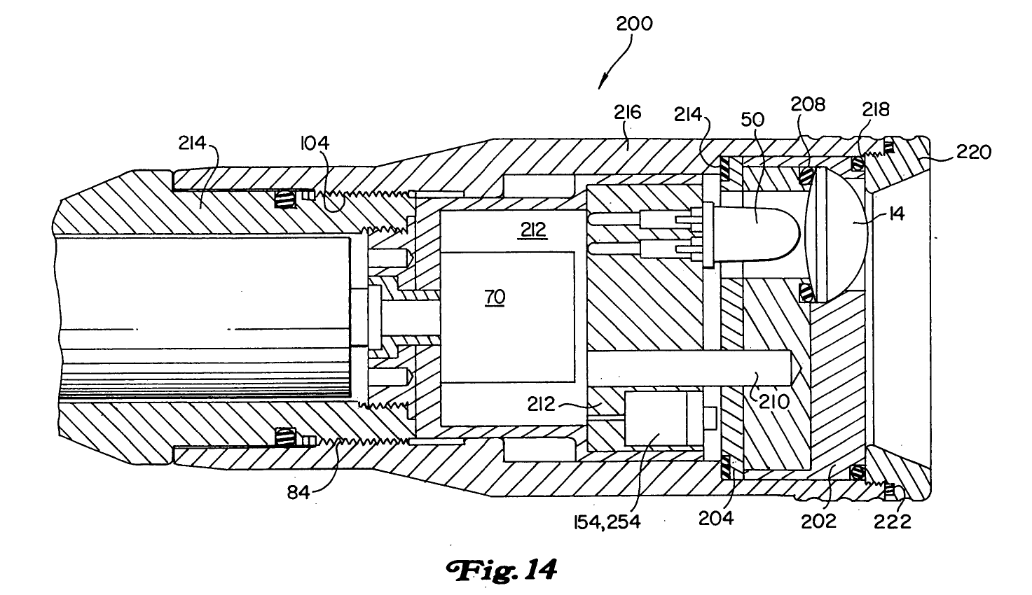

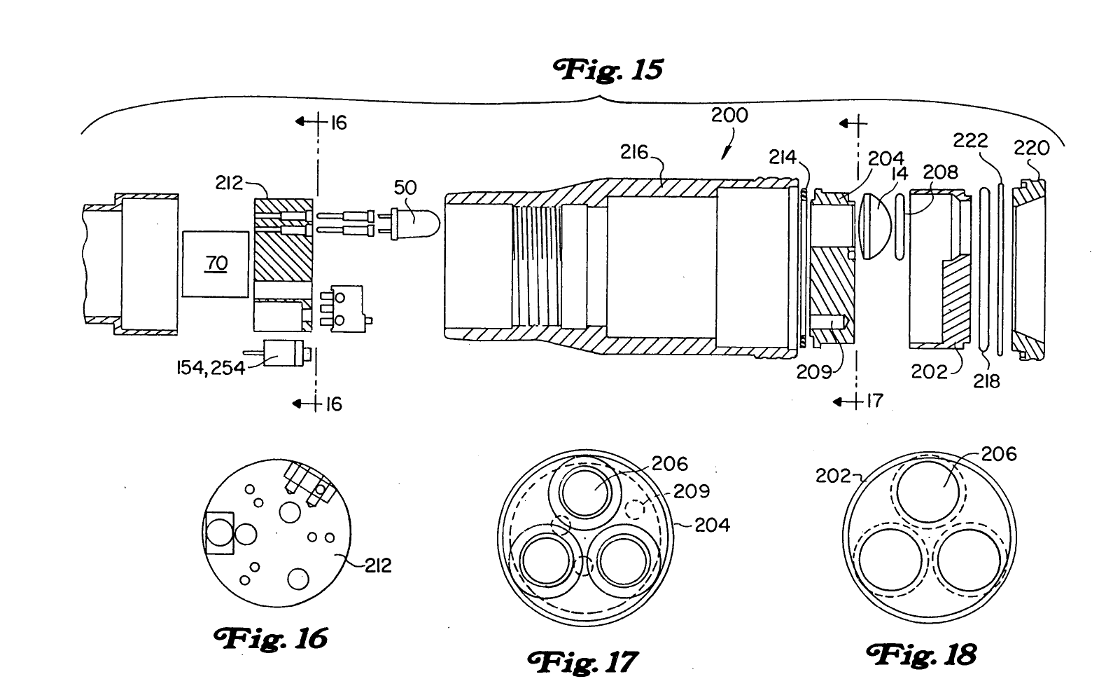

Turning now to FIGS. 14-18, in another flashlight embodiment 200, three lamps or LED's 50 are provided, and a lens 14 is aligned and associated with each LED 50. Except as described below, the flashlight 200 is similar to the flashlight 10 described above. A lens ring 202 and a lens base 204 have three openings 206 for receiving or holding three lenses 14. Each lens 14 is secured in place on the lens ring 202 within an O-ring 208. The lens ring 202 and lens base 204 are attached to each other by screw threads, adhesives, etc., after the lenses 14 are placed into the lens ring 202. Counterbores 209 extend into the back surface of the lens base 204. Anti-rotation pins 210 extend from the switch housing 212 into the counterbores. As the switch housing 212 is fixed to the rear housing section 214, the lens ring 202 does not rotate with the front housing. The lenses 14 in the lens ring can move longitudinally towards and away from the LED's, while staying aligned with the LED's. The switch housing 212 holds three LED's 50, with each LED aligned with a lens 14. A Teflon (Flourine resins) washer 214 between the front housing section 216 and the lens base allows the front housing section 216 to rotate and slide smoothly against the lens base 204, as the front housing section 216 is rotated to turn on or focus the flashlight 200. Similarly, a low friction O-ring or seal 218 supports the lens ring 202 within the front housing section 216, while allowing for rotational and front/back sliding movement between them. A front cap 220 is sealed against the front housing section 216 with an O-ring or seal 222.

In use, as the front housing section 216 is twisted or rotated, it moves front to back via the interaction of the screw threads 104 and 84. The LED's 50 remained fixed in place. The lenses 14 move front to back, with movement of the front housing section, but they do not rotate as the lens ring 202 and lens base 204 are held against rotation or angular movement by the pins 210. Consequently, light from each of the three LED's 50 can be focused with movement of the front housing section 216. Of course, the design shown in FIGS. 14-18 is suitable for use with 2, 3, 4 or any number of additional LED's.

Turning to FIG. 20, in an alternative timer circuit 250, the switch 154 is removed and replaced with a continuous or permanent on switch 254. The switch 254, when closed, connects the LED 50 and the resistor R4 directly to the battery 90. All of the other components are bypassed. As a result, when the switch 254 is closed, the timer circuit 250 is inactive or disabled, and illumination by the LED is controlled purely by the switch 60. This design is advantageous where the user wants the flashlight to remain on until manually turned off using the switch 60, which is actuated by turning the front housing section. When the switch 254 is in the open position, the timer circuit shown in FIG. 20 operates in the same way as the timer circuit 70 shown in FIG. 19. With the switch 254 open, the timer circuit 250 automatically turns the flashlight off after a preset interval of time determined by the capacitors C1 and 152. The timer circuit 250 otherwise operates in same way as the timer circuit 70, except as described above.

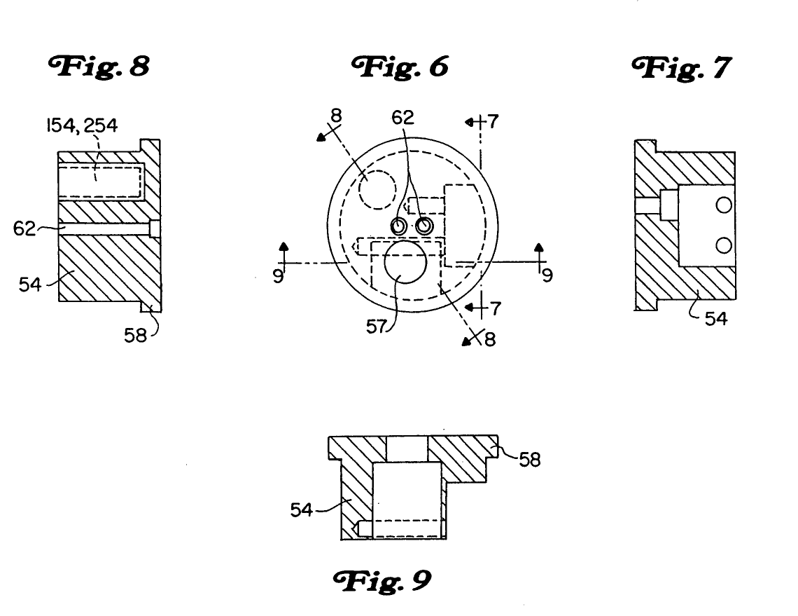

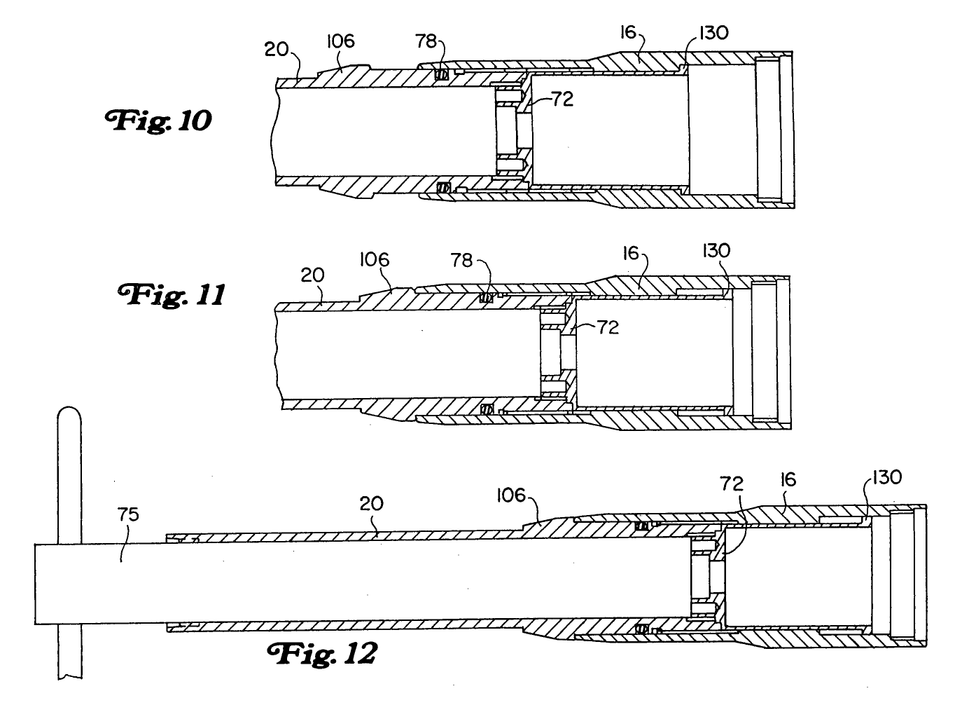

Referring momentarily to FIGS. 5 and 17, the switch 154 or 254 is set in the open or closed position by removing the front cap 12, along with the lens 14, O-ring 40, and the lamp housing 42 (which remain as a single sub-assembly with the lamp housing pressed into the front cap 12). Referring to FIG. 6, an instrument, such as a small screwdriver blade, or even a pen or pencil tip, is inserted through the access hole 57 in the switch housing 54 to set the switch 154 or 254 to the desired position. The switch 154 can be set to a shorter or a longer time interval before automatic shutoff. If the switch 254 is used, the switch positions are automatic shutoff mode (determined by the capacitors), or “permanent on” where the flashlight acts as a conventional flashlight controlled entirely by the switch 60, and with no automatic shutoff feature. Referring to FIG. 14, in the embodiment 200, the switch 154 or 254 is set by removing the front cap 220, along with the O-rings 208 and 222, the lens ring 202, the lens base 204, and the lenses 14 (which remain as single sub-assembly). The switch 154 or 254 is then readily directly accessible.

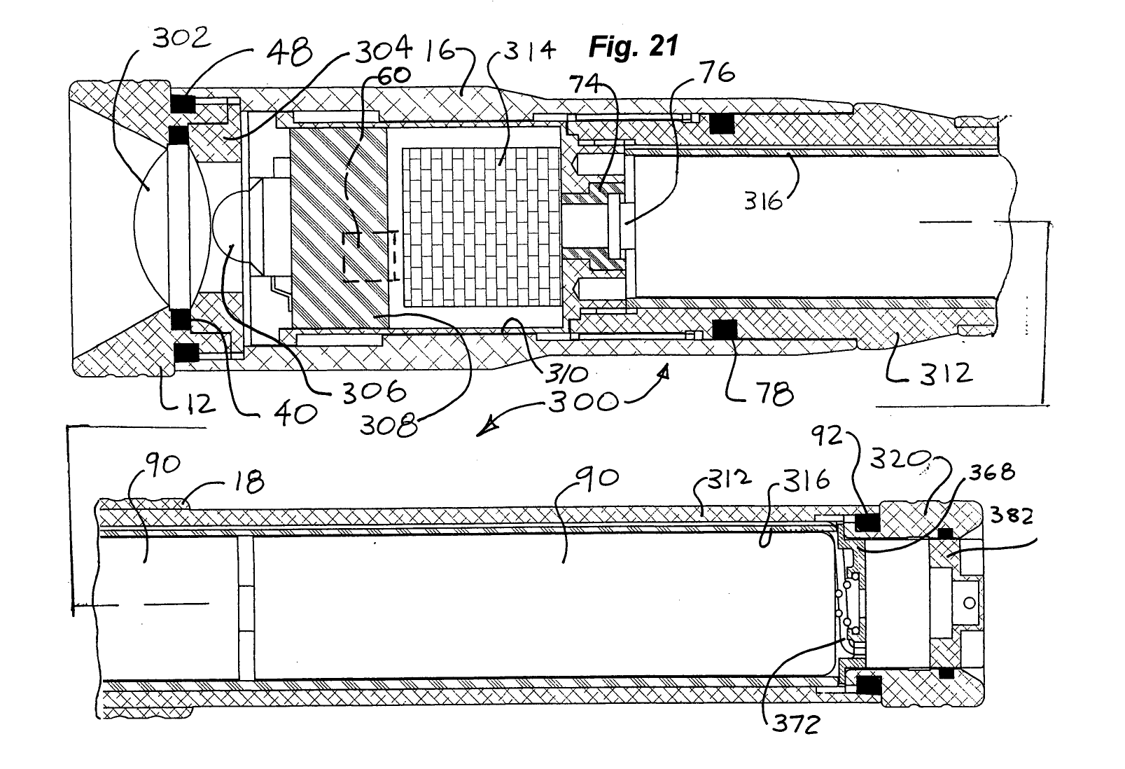

Turning to FIG. 21, an alternative embodiment flashlight 300 includes additional features, which may be used alone, or in combination with each other, and with one or more of these features also usable in the flashlights shown in FIGS. 1, 13, and 15. These features include a dimmer, which allows the brightness of the bulb or LED(s) to be adjusted by turning an end knob or cap. Another feature includes a current controller which may be used to maintain the brightness, as battery power decreases. Another feature is a switch which may be momentarily pushed in and switched on, or pushed in and held in an on position to provide maximum brightness, regardless of other control functions in use. An additional function allows the timer described above to be made adjustable, using a knob or switch on the flashlight.

As shown in FIG. 21, in the flashlight 300, a lens 302 is held within a lens housing 304. One or more LEDs 306 or bulbs are held in place on an LED holder 308. The LED holder 308 is supported within a switch housing tube 310, similar to the switch housing tube 72 described above. A rear housing 312 is threaded into a front housing 16. The rear housing 312 may be the same as the rear housing 20 shown in FIGS. 1-5, except that it preferably has a larger internal bore, to accommodate a plastic tube liner 316.

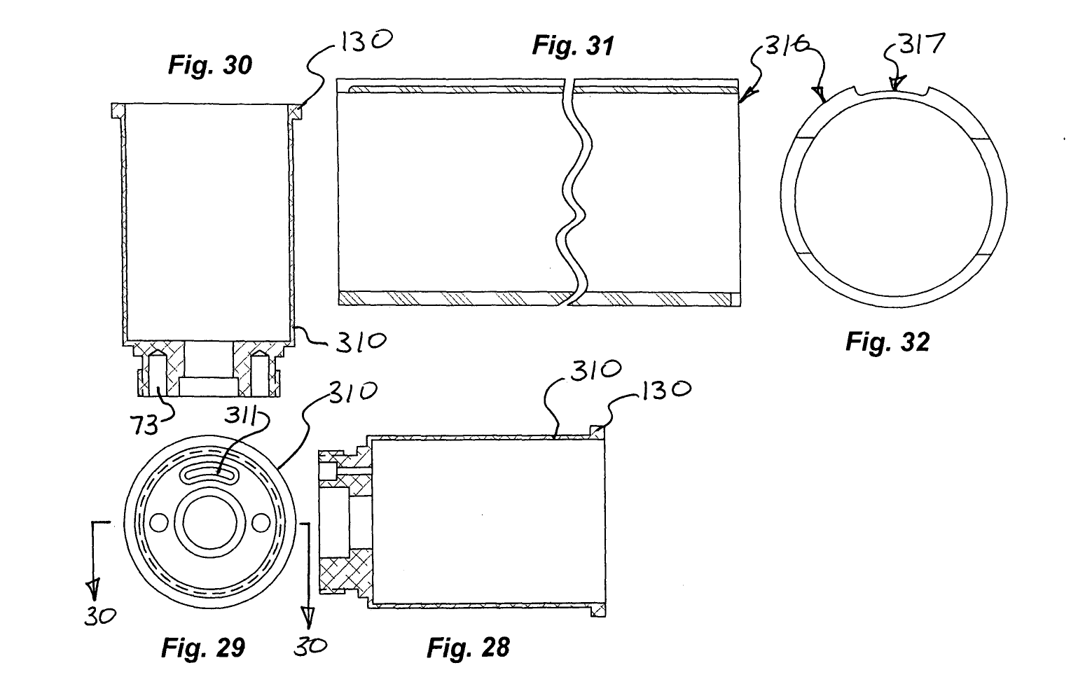

Referring momentarily to FIGS. 31 and 32, the tube liner 316 includes a wiring slot 317, to provide space for wires running from a circuitry module 314 within the switch housing tube 310 to the back end of the flashlight 300. Referring to FIGS. 28-30, the switch housing tube 310 similarly includes a wire slot or opening 311 for routing of the wire bundle 372.

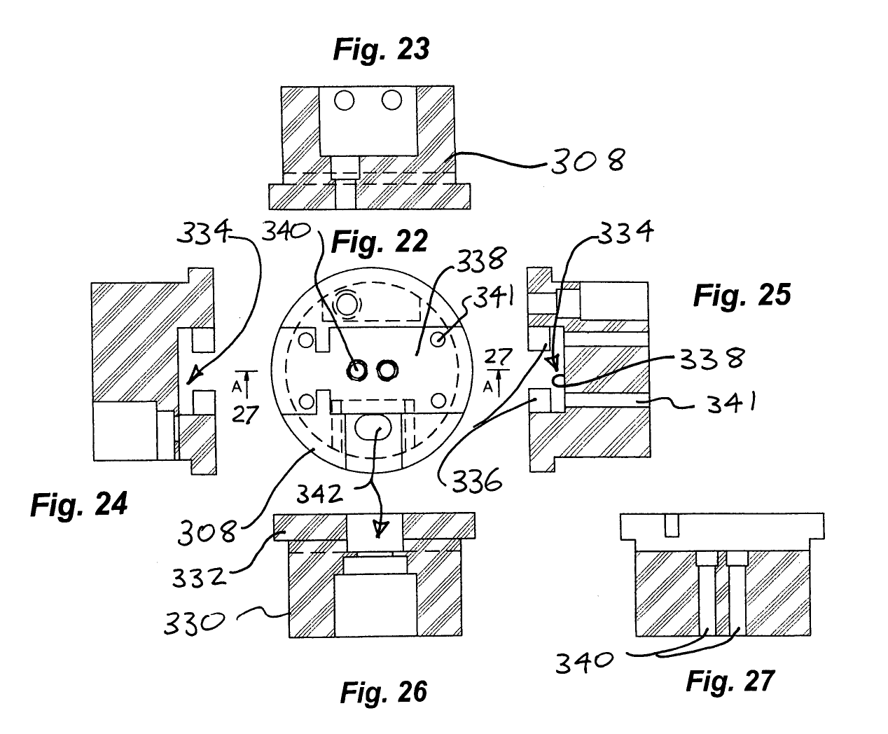

Turning now to FIGS. 22-27, the LED holder 308 is similar to the switch housing 54 shown in FIGS. 6-9. However, the LED holder 308 is preferably made of a metal, e.g., aluminum, to better also act as a heat sink for use with higher power LEDs. The cylindrical body 330 of the holder 308 fits within the front end of the switch housing tube 310, with the head or rim 332 acting to position the holder 308 within the switch housing tube 310. An LED slot 334 is formed between a base or land area 338 and overhanging tabs 336. Central LED lead openings 340 extend through the holder 308, for use with LEDs or lamps having straight leads. Side LED lead openings 341 are provided for use with LEDs having lateral leads. Accordingly, the holder 308 can be used with a large variety of LEDs or lamps. A switch pin opening 342 extends through the holder 308 to allow on/off switching of the microswitch 60, with twisting movement between the front and rear housings as described above. The base area 338 provides a flat and smooth surface for mounting a LED, and to better allow for heat flow from the LED into the holder 308. Thermal grease may be provided on the base area 338 to improve the heat flow path from the LED 306 into the holder 308, and ultimately to the front housing 16.

The holder 308 shown in FIGS. 22-27 is adapted for holding a single LED (or bulb). LEDs having lateral leads are installed by placing the LED on the base area 338 and then sliding the LED to a central position, so that the tabs 336 secure the LED in place. Straight lead LEDs are installed by simply inserting the straight leads into the lead openings 340.

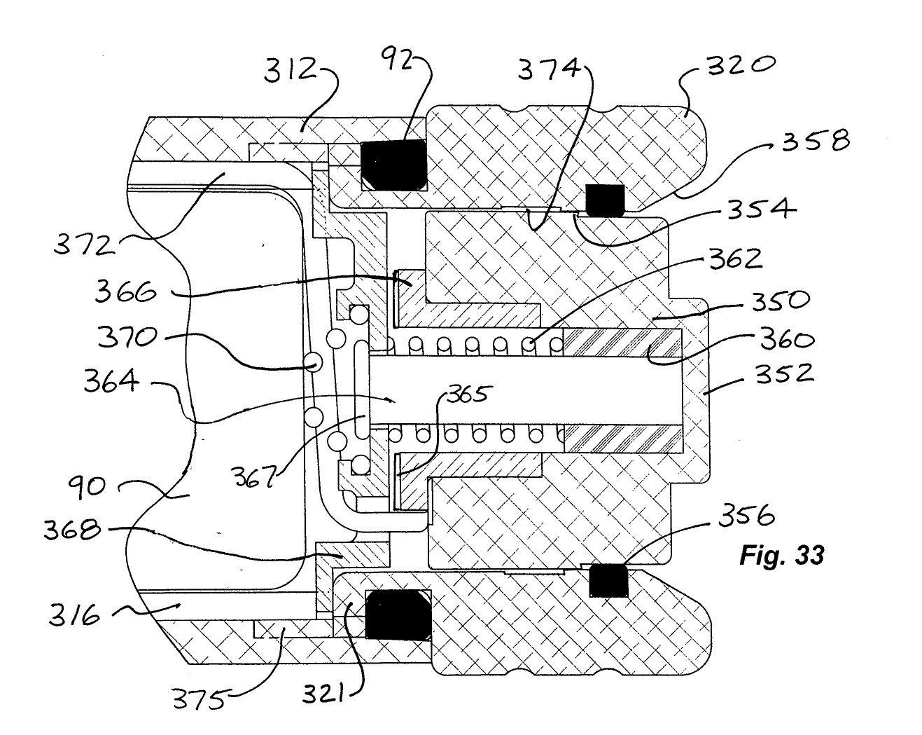

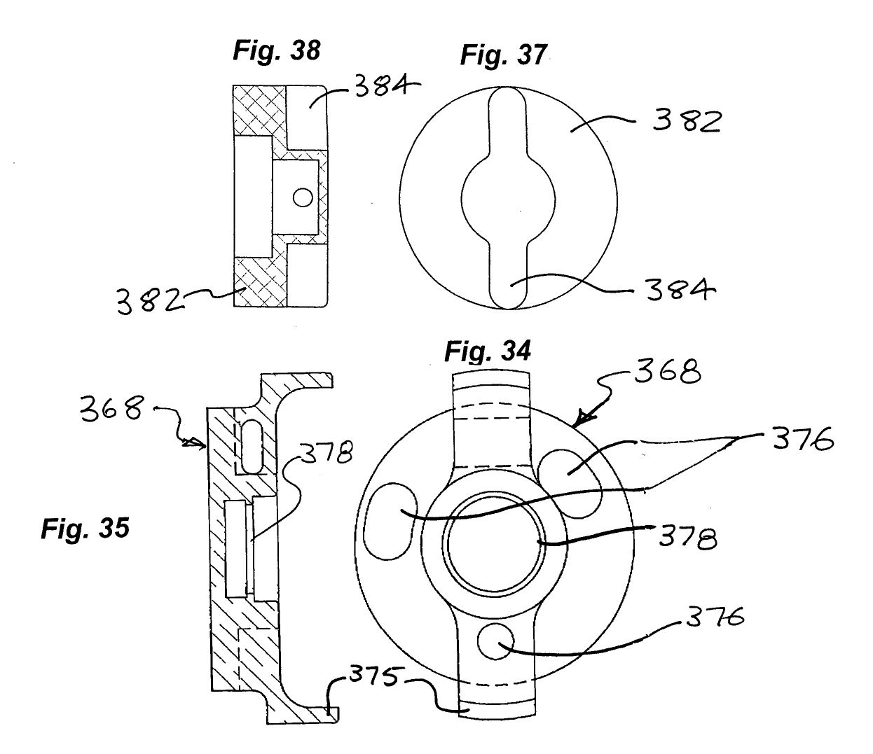

FIG. 33 is an enlarged view of one embodiment of the back end of the flashlight 300 shown in FIG. 21. An end cap 320 having a conical opening 358 is threaded into the back end of the rear housing 312. A spring plate 368 (preferably brass) is secured between the back end of the tube liner 316 and a forward flange 321 of the end cap 320. Referring momentarily to FIGS. 34 and 35, the spring plate 368 includes a spring retainer or opening 378 and clearance holes or slots 376 to allow wires to pass through a spring plate 368. Anti-rotation tabs 375 on the spring plate 368 fit within slots in the tube liner, to prevent rotation of the spring plate 368, when the end cap is unscrewed to change the batteries. Referring again to FIG. 33, the back end of a battery spring 370 is secured within the spring retainer 378 of the spring plate 368. The front end of the battery spring 370 contacts a battery 90.

A push button 350 having a raised center 352 is slidably or telescopically secured within the end cap 320. A push button seal 356, such as an O-ring, seals the push button 350 with the end cap 320, while allowing longitudinal or in/out movement. Referring still to FIG. 33, an insulator pin 364 extends through the spring plate 368 and is secured within a spacer 360 in the push button 350. A compression spring 362 around the pin 364 pushes the push button 350 outwardly, until a head 367 of the pin 364 contacts the spring plate 368, preventing further outward movement of the push button 350. A contact ferrule 366 (preferably copper) is secured to the push button 350. Spring fingers 365 on the front of the ferrule 366 contact the spring plate, when the button 350 is pushed in. One or more wires 372 extending rearwardly from the circuitry module 314 are attached and electrically connected to the contact ferrule 366.

In use, the flashlight 300 may be turned on and off by twisting the front housing, as described above in connection with the flashlight shown in FIGS. 1-5. This movement operates the main power switch 60. The push button 350 in the flashlight 300 and the circuitry module 314 provide additional functions. These additional functions are provided via circuitry in the circuitry module 314 and via the push button 350.

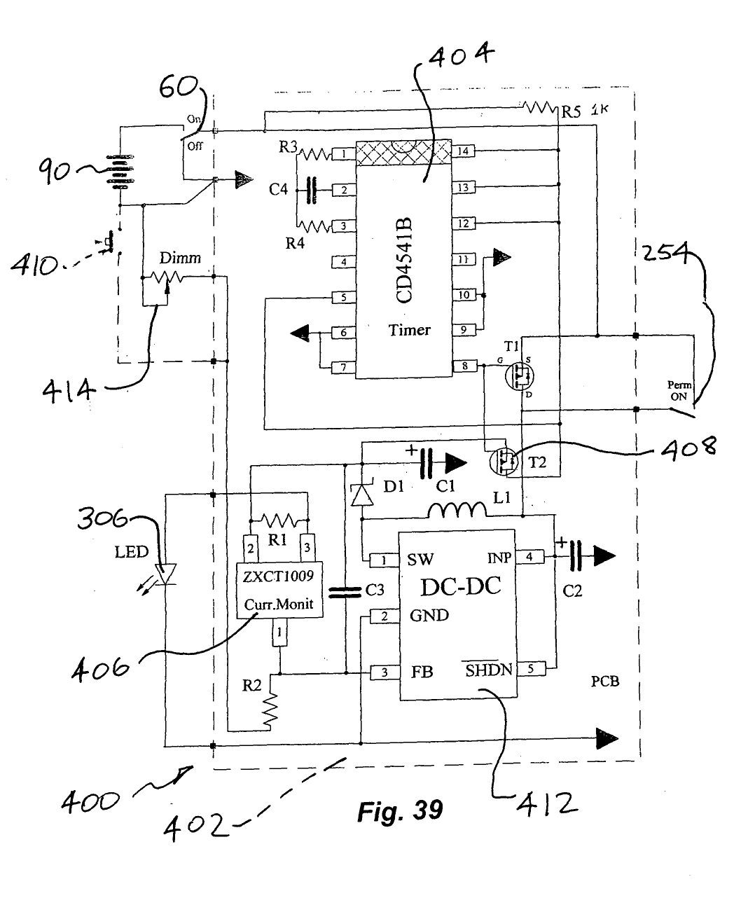

Referring to FIG. 39, a flashlight circuit 400 has a timer 404, a current monitor 406, a current controller 412, MOSFETs 408, preferably on a circuit board 402 within the circuitry module 314, along with the discrete components shown. The current controller 412 allows current through the LED 306 to be maintained at a constant level, even as the voltage of the battery(s) 90 drops over time. In general, the current control function is used only when sustained maximum brightness is desired, since use of the current controller shortens battery life, or the output of the current controller is controlled via a potentiometer.

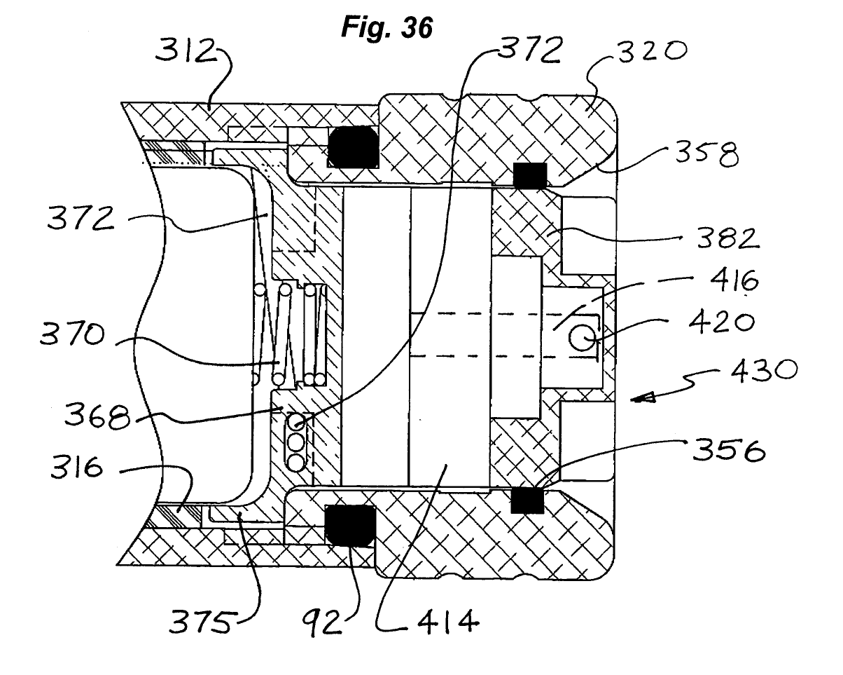

Referring to FIGS. 21, 33 and 39, the flashlight 300 can be turned on by twisting the front housing 16 relative to the rear housing 312. This movement causes the microswitch 60, shown in FIG. 21, to switch on. Referring to FIG. 33, when the push button 350 is pushed in, the contact ferrule 366 moves forward into electrical contact with the spring plate 368, closing the switch 410 shown in FIG. 39. The switch 410 is shown in dotted lines in FIG. 39 because FIG. 39 shows circuitry which may also be used in the flashlight shown in FIG. 36. Current flow from the batteries 90 to the LED 306 is then maintained by the current controller 412. Consequently, the LED 306 provides maximum brightness, regardless of battery condition. This function allows the user to quickly get maximum brightness by pushing the push button 350, regardless of other functions in use (e.g., timer, dimmer, blinking), since the push button activation of the current controller overrides all other functions. Consequently, this operation is especially useful in an emergency.

As shown in FIG. 33, due to the action of the spring 362, once the push button 350 is released, it will return to the out or original position, opening the switch 410 as the ferrule 366 separates from the spring plate 368. The current controller 412 is then disengaged. Any of the other functions can then resume. To maintain maximum brightness, the push button 350 is pushed in, and then slightly to one side via finger force on the raised area 352. This causes the shoulder 354 on the push button 350 to engage into the groove 374 on the inside surface of the end cap 320. Consequently, the push button 350 is held in the on position, the switch 410 remains closed, and maximum brightness is maintained indefinitely via the current controller 412. If the flashlight 300 is used under water, the push button 350 may be moved in purely via water pressure. Consequently, the flashlight 300 is automatically placed into a maximum brightness mode when submerged.

The MOSFETs 408 are controlled by the timer 404 to switch higher levels of current on and off, based on timer signals. The current monitor 406 detects current by measuring voltage drop across a resister, and sends a signal to the current controller 412.

To resist corrosion, the front and rear housings, and other aluminum components, such as the front and end caps, are preferably anodized, inside and out. Since anodize is an electrical insulator, electrical connections are made through the wires 372, rather than through the components themselves. This provides for more reliable electrical connections, reduces corrosion and corrosion related failures, and simplifies manufacture as masking during finishing of metal components is eliminated.

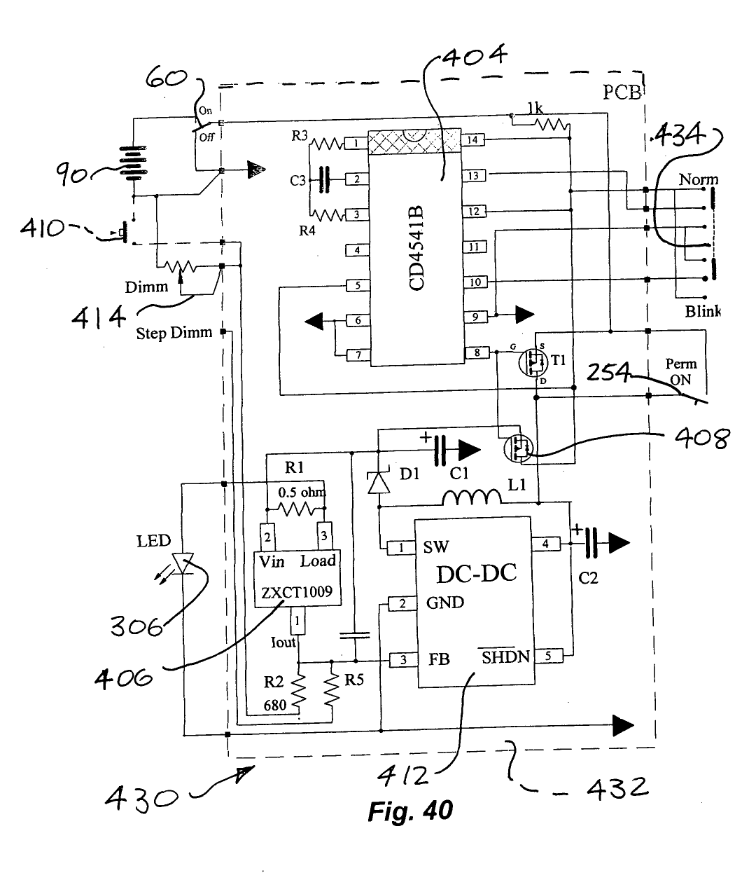

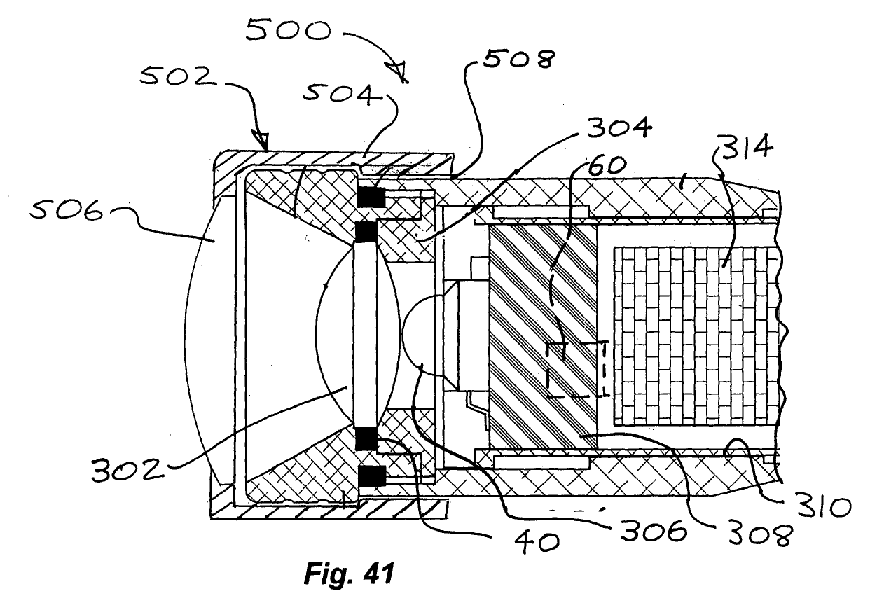

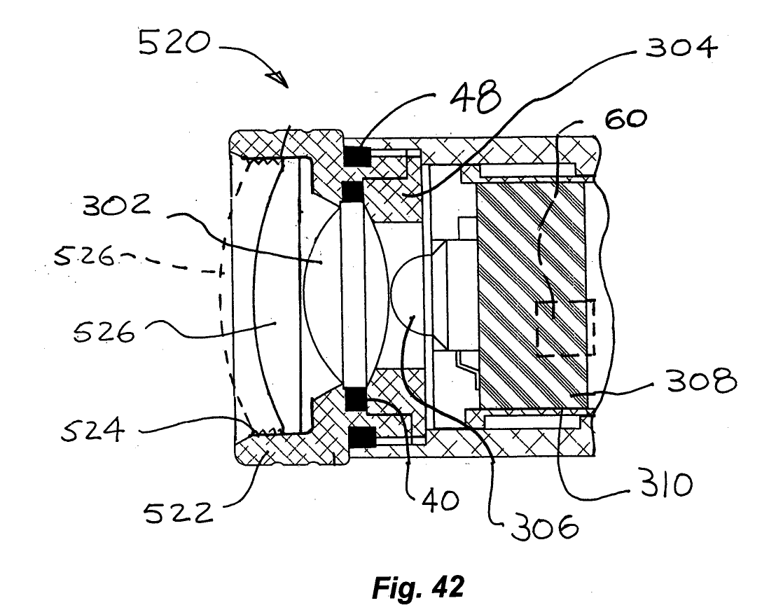

Turning to FIG. 36 and 40, in an alternative flashlight end design 430, a pivotable or rotatable end knob 382 is provided in place of the push button 350. As shown in FIGS. 37 and 38, the end knob 382 has finger tabs 384, to facilitate turning the end knob 382 with the user's fingers. The end knob 382 is mechanically connected to a variable resister 414 electrically connecting to the circuitry module 314 through the wire bundle 372. A pin 420 attaches the end knob 382 to the shaft 416 of the dimmer 414. The variable resistor is attached to the back surface of spring plate 368. The variable resister 414, as shown in FIG. 40, varies current flow through the LED 306, thereby acting as a dimmer to adjust brightness.

In the design shown in FIGS. 33 and 36, various styles and types of batteries may be used including single use batteries as well as rechargeable batteries. Preferably two or three batteries may be used, providing 3 volts or 4.5 volts. The batteries may be AAA, AA, C, D, or N cells, or other equivalent batteries. Of course, other types and numbers of batteries may also be used. To change the batteries, the end cap 320 is unscrewed from the rear housing 312. The end cap 320 rotates, while the end knob 382, variable resistor 414, spring plate 368, spring 370, wires 372 and sleeve 316 remain in place. The sleeve 316 is fixed against movement by friction, or optionally adhesives. The spring plate anti-rotation tabs 375 on the spring plate prevent rotation of the spring plate 368 as the end cap 320 is rotated. As the variable resistor 414 and the end knob 382 are attached to the spring plate 368, these components also remain in place. After the end cap 320 is unscrewed, the end cap, and the components 382, 414, 368 within the end cap, are pivoted (as a subassembly) out of the way, to change the batteries. Similarly, in the design shown in FIG. 33, the end cap rotates free of the internal components 350, 366, 368, 364, until the end cap 320 disengages from the screw threads on the rear housing 312. Then, the subassembly of the end cap and the internal components is moved to one side, to change the batteries. Since the push button 350 or end knob 382, and their associated electrical connections, stay with the end cap 320, the wire bundle 372 is provided with sufficient extra length and flexibility to allow the end cap 320 to be unscrewed and pivoted to one side, while batteries are changed.

Referring to FIG. 40, in an alternate design, a blinking function may also be provided via the timer chip 404. A switch 434, which may be internal, or associated with either the pushbutton or end knob turning movements, switches the blinking function on and off. As shown in FIG. 41, in an alternative flashlight design 500, a second lens 506 is included in a removable accessory 502. The accessory 502 has arms or a cylindrical body 504 that fits over the front end cap 12. The arms or body 504 are flexible and can spring out to fit over and/or snap onto the front end cap. The position of the second lens 506 relative to the first lens 302 may be fixed, via the fit between the accessory and the front end cap. The second lens focuses the light into a more narrow beam, to provide a brighter spot at greater distances from the flashlight. If desired, the spacing between the first and second lens can be reduced by shortening the conical section of the front end cap. In another two lens design 520 shown in FIG. 42, a second lens 526 is contained within and is part of the flashlight. In this design, the second lens 526 is mounted in the front end cap 522. The second lens 526 may be fixed in position relative to the first lens 302, or it may be moveable or adjustable via screw threads 524 or a sliding adjustment. Moving the second lens 526 relative to the first lens 302 changes the focus characteristics, as may be desired.

Thus, novel flashlights have been shown and described. Various changes and modifications may be made without departing without the spirit and scope of the invention. The inventions, therefore, should not be limited, except by the following claims, and their equivalents.

What is claimed is:

1. A flashlight comprising:
a front housing section;
a rear housing section attached to the front housing section via screw threads;
a light source supported on one of the front and rear housing sections;
a current controller;
a first switch connectable to a power source and electrically linked at least indirectly to the light source; and
a second switch for switching the current controller into and out of circuitry providing electrical power to the light source.

2. The flashlight of claim 1 wherein the second switch comprises a push button on the rear housing.

3. The flashlight of claim 2 further including an end cap on the rear housing section, and wherein the push button comprises a shoulder engageable with a groove in the end cap, for holding the second switch in a closed position.

4. The flashlight of claim 1 further comprising a circuitry module including a timer circuit for automatically turning off power to the LED after a selected time interval, when the current controller is switched out by the second switch.

5. The flashlight of claim 1 wherein the second switch provides full power to the light source when the second switch is closed, regardless of the position of the first switch.

6. The flashlight of claim 2 wherein the push button is spring biased into an open position.

7. A flashlight comprising:
a front housing section;
a rear housing section attached to the front housing section via screw threads;
a switch actuated by turning the front housing section relative to the rear housing section;
a light source supported on one of the front and rear housing sections;
a circuitry module including a dimmer; and
a knob on the rear housing section linked to the dimmer, for controlling brightness of the light source via the dimmer.

8. The flashlight of claim 7 wherein electrical connections are made through wires, and no electrical connections are made through the front or rear housings.

9. The flashlight of claim 7 further comprising an end cap engaged to screw threads on the rear housing, with the end cap sealed against the knob and also rotatable relative to the knob, to change batteries.

10. The flashlight of claim 9 wherein the knob is held against rotation by anti-rotation means in the rear housing.

11. A flashlight comprising:
a machined metal housing for holding one or more batteries
battery contacts in the housing for making electrical contact with batteries contained within the housing;
a light source adjacent a first end of the housing;
a switch; and with the battery contacts and the switch and the light source connected via wires and with no electrical connections made via conduction through the housing.

12. A flashlight comprising:
a housing having a front end and a back end;
a light source adjacent to the front end of the housing;
an end cap attached at the back end via screw threads;
a push button within the end cap;
a switch adjacent to the back end and actuated via movement of the push button;
a seal between the push button and the end cap, with the end cap rotatable about the push button, while the push button remains largely stationery, to unscrew the end cap from the back end of the housing, to replace batteries.

13. The flashlight of claim 12 further comprising a second seal between the end cap and the housing.

14. The flashlight of claim 12 further including an anti-rotation element on the switch, to prevent the switch from rotating as the end cap is removed from the housing.

15. The flashlight of claim 12 further including a shoulder on the push button engageable into a groove on an inside surface of the end cap, for holding the push button in a first position against a spring force.

16. A flashlight comprising:
a housing having a front end and a back end;
a light source adjacent to the front end;
an end cap attached at the back end via screw threads;
a finger knob within the end cap;
a variable resistor adjacent to the back end of the housing and actuated via turning movement of the finger knob, and with the variable resistor electrically linked at least indirectly to the light source;
a seal between the finger knob and the end cap, with the end cap rotatable about the finger knob, while the finger knob remains largely stationery, to unscrew the end cap from the back end of the housing, to replace batteries.

17. A flashlight comprising:
a housing;
a light emitting element adjacent to a first end of the housing;
a first lens adjacent to the light emitting element; and
a second lens adjacent to the first lens.

18. The flashlight of claim 17 with the second lens supported on an accessory attachable onto an outside surface of the housing.

19. The flashlight of claim 17 with the first lens and the second lens supported on a front end cap attached to the first end of the housing.

20. The flashlight of claim 19 further comprising a second lens adjustment on the front end cap, to allow adjustment of a spacing between the first lens and the second lens.
